(19) United States
(12) Patent Application Publication
(10) Pub. No.: US 2026/0311269 A1
(43) Pub. Date: Oct. 8, 2026

(54) Adaptive Preference Engine with Soft-Ranking and Explainable AI for Travel Recommendations

(71) Applicants: Ashton Lightfoot, Atlanta, GA (US); Clinton Brooks, Atlanta, GA (US)

(72) Inventors: Ashton Lightfoot, Atlanta, GA (US); Clinton Brooks, Atlanta, GA (US)

(21) Appl. No.: 19/171,306

(22) Filed: Apr. 6, 2025

(51) Int. Cl. G06Q 50/14; G06F 16/2457; G06F 16/9535

(52) U.S. Cl. CPC G06Q 50/14; G06F 16/24578; G06F 16/9535

(57) ABSTRACT

The present invention relates to a travel planning system and method that enables users to customize trip recommendations through real-time, soft-ranking of personal preferences and dynamically generated explanations. Unlike traditional itinerary generators that rely on fixed parameters or opaque algorithms, this system allows travelers to indicate relative importance for various factors such as budget, luxury, pace, interest type, and proximity via an interactive user interface. An adaptive AI engine ingests the soft-ranked preference weights and applies them to a dynamic scoring matrix that generates a prioritized set of recommended options across accommodations, activities, dining, and transit. Each recommendation is accompanied by a transparent, real-time explanation that clarifies why it was selected, referencing the user's weighting decisions and the trade-offs made. This invention improves traveler trust, decision-making clarity, and itinerary satisfaction by enabling nuanced control over preferences and making AI decision logic fully visible to the user.

### FIELD OF THE INVENTION

This invention relates generally to artificial intelligence systems in the field of travel technology, and more particularly to systems and methods for generating personalized travel itineraries using user-adjustable preference weighting and real-time explainability.

### BACKGROUND OF THE INVENTION

Conventional travel recommendation engines often rely on fixed rules or hidden algorithms to generate itineraries or suggested activities, with limited user customization and no clarity regarding why recommendations were made. Existing systems provide binary filters but lack mechanisms for users to prioritize goals dynamically. Moreover, most systems do not provide clear explanations for their suggestions, leading to mistrust or inefficiency.

### SUMMARY OF THE INVENTION

The present invention introduces a novel adaptive preference engine that enables users to assign soft-ranked weights across multiple trip-related criteria—such as cost, luxury, proximity, pace, and activity type. These inputs are processed in real-time by an AI scoring engine that generates itinerary components tailored to the weighted profile. Each result includes a dynamically generated explanation describing how the selected item satisfies the user's expressed preferences, improving transparency and decision-making.

### BRIEF DESCRIPTION OF THE DRAWINGS

FIG. 1 illustrates an overview of the adaptive preference engine architecture. The system includes a user input interface for collecting travel preferences, a preference vectorization engine that converts those inputs into numerical vectors, a scoring engine that ranks available itinerary options, an explanation generation module that produces justifications for each selection, and a ranked itinerary builder that delivers output to the user interface.

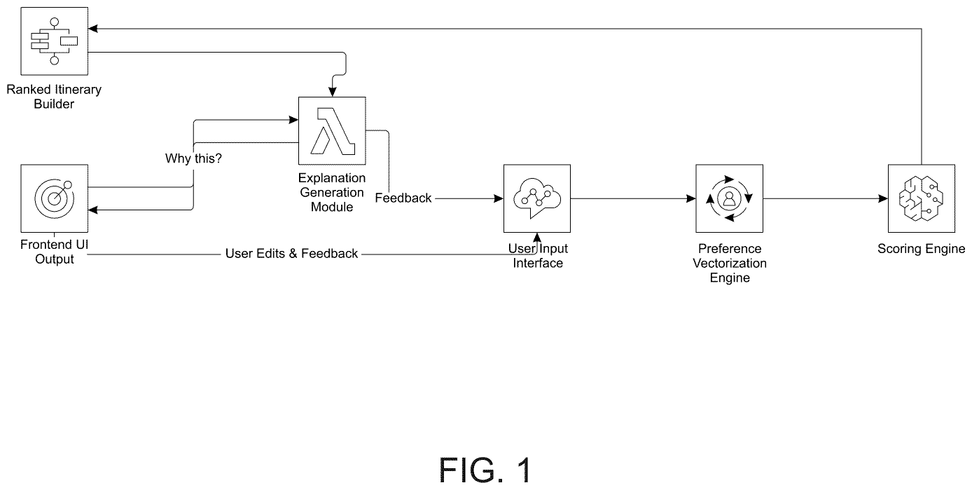

FIG. 2 is a process flow diagram of the soft-ranking and scoring procedure. The flow depicts how user-specified weights are vectorized, applied to available activities, ranked according to preference rules, and then combined into a balanced itinerary draft that is rendered with explanatory data.

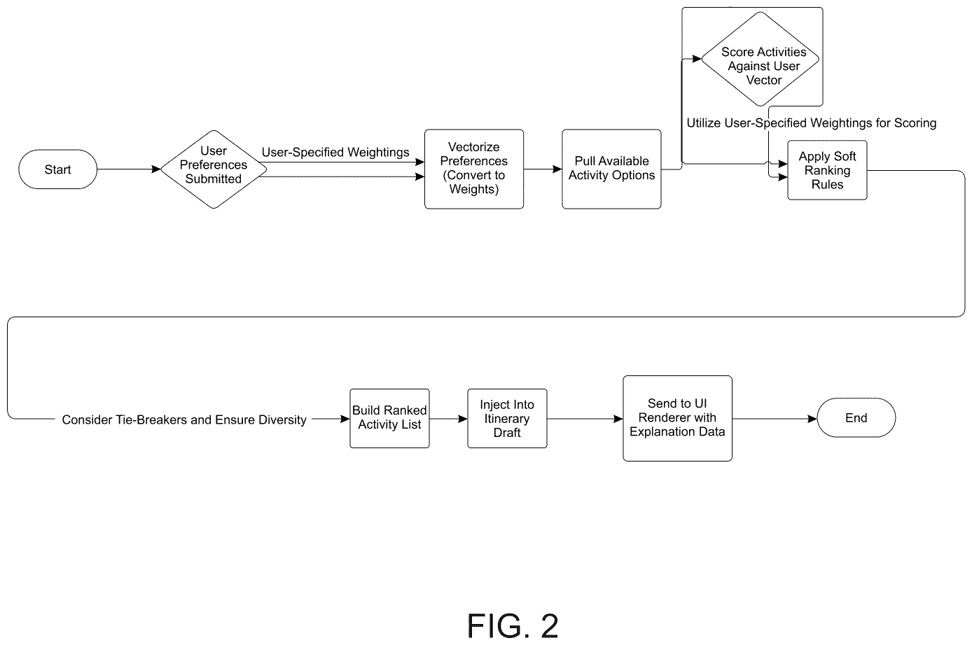

FIG. 3 is a component interaction diagram representing the graphical user interface elements used for capturing and adjusting user preferences. Sliders and toggles such as budget sensitivity, pace, food versus culture, and indoor/outdoor balance interact dynamically with the scoring engine to generate real-time feedback and previews.

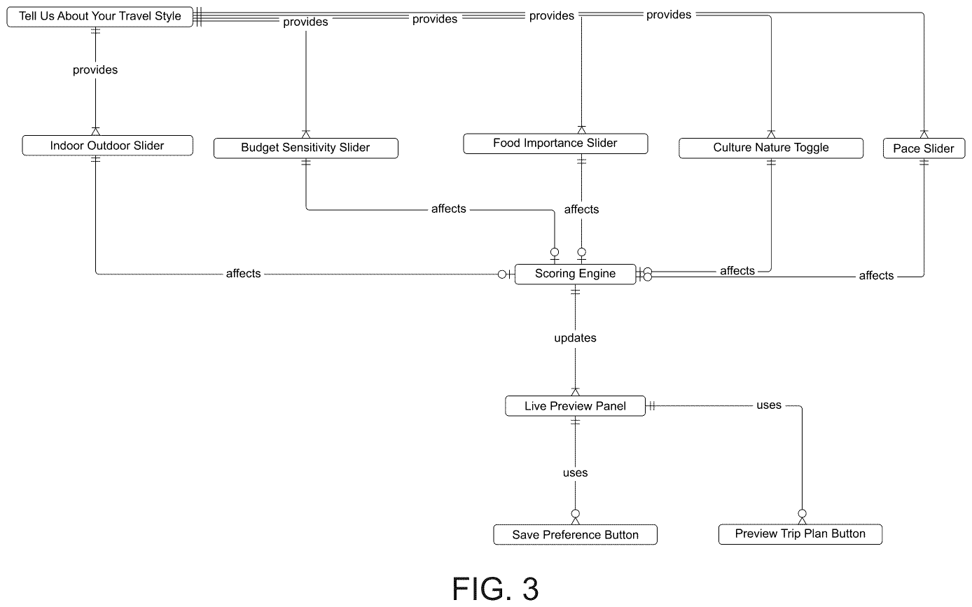

FIG. 4 is a process flow diagram showing the explainability feedback loop. It details how the system compares ranked elements, generates natural-language explanations, integrates them into the user interface, logs generated explanations for refinement, and continuously adapts the model based on user feedback.

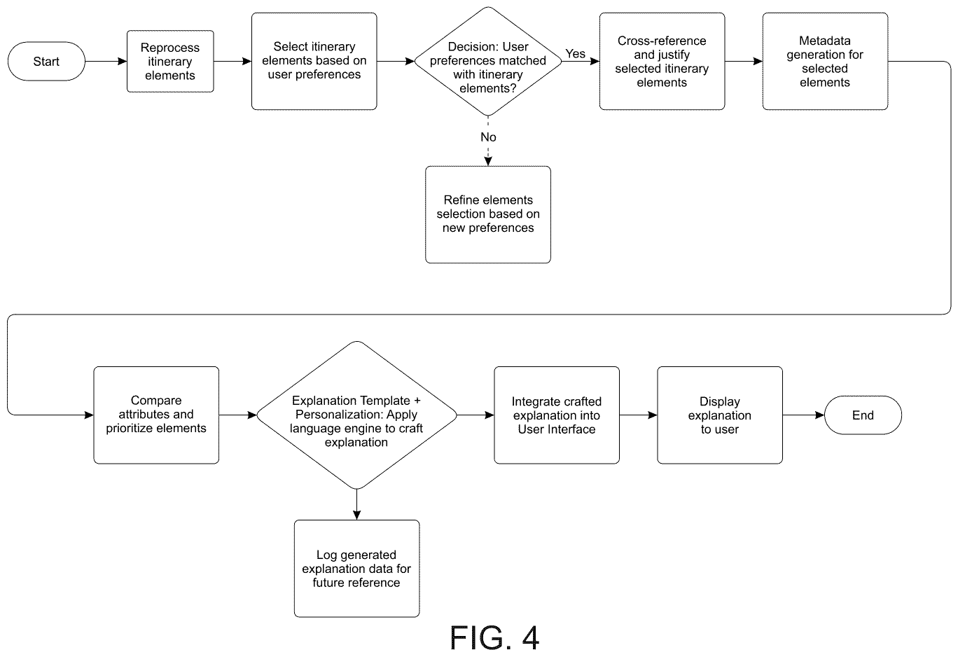

### DETAILED DESCRIPTION OF THE INVENTION

The system comprises the following modules:

User Preference Interface: A graphical interface allowing users to rank or weight travel-related criteria using sliders or selectors. Weights may be updated interactively and rebalanced dynamically.

Preference Vectorization Engine: Converts user inputs into a normalized vector representing weighted preferences, which is then passed to a scoring algorithm.

Scoring and Ranking Module: Applies the vector to candidate options across categories (e.g., accommodations, activities, restaurants) and generates a prioritized list. Multi-objective optimization is used to balance trade-offs among preferences.

Explainable AI Output Generator: Produces natural-language explanations justifying each selected item. Explanations may be template-based, rules-driven, or generated by AI models (e.g., via transformer architectures), referencing user weights and data source attributes.

Feedback Logging and Adaptation: Logs user interactions with explanations and selections, enabling iterative improvement of scoring weights and explanation clarity.

### Benefits and Improvements

This invention enables personalized itinerary results based on nuanced preference trade-offs, improves user trust through explainable decision output, allows real-time experimentation with weights and instant feedback on results, and supports data privacy by avoiding overreliance on inferred preferences.

1. A method for generating personalized travel itineraries, comprising the steps of:
(a) receiving user-defined relative weights for a plurality of travel preferences;
(b) normalizing the user-defined weights into a preference vector;
(c) scoring candidate travel options using the preference vector to generate a ranked set of itinerary elements;
(d) providing a real-time, natural-language explanation for each selected itinerary element that describes how the selection satisfies the user-defined preferences.
(e) integrating real-time external data sources including weather, transit availability,
venue capacity, and pricing data to dynamically adjust recommendations and
itinerary elements in response to changing environmental factors.

2. The method of claim 1, further comprising the step of dynamically updating the user-defined weights and recalculating the itinerary in real-time based on user feedback or additional input.

3. The method of claim 1, wherein the preferences comprise at least one of: budget, luxury, location, activity type, and pace, and the relative weights are expressed as continuous values within a predefined range.

4. A system for generating personalized travel itineraries, comprising:
(a) a user input module configured to receive user-defined relative weights for a plurality of travel preferences;
(b) a preference vectorization engine configured to normalize the user-defined weights into a vector representation;
(c) a scoring engine configured to score candidate travel options based on the normalized preference vector and generate a ranked set of itinerary elements;
(d) an explanation generation module configured to provide a natural-language explanation for each selected itinerary element, based on how the element satisfies the user-defined preferences;
(e) cross-platform synchronization, enabling consistent preference modeling, itinerary updates, and explanation generation across multiple devices and platforms in real-time.

5. The system of claim 4, wherein the explanation generation module is configured to provide dynamic explanations using a pre-determined template or machine-learning generated reasoning.

6. The system of claim 4, wherein the user input module further comprises an interactive user interface with sliders or input fields allowing users to adjust the relative weights of their preferences in real-time.

7. The system of claim 4, further comprising a feedback loop configured to log user interactions with the itinerary and explanations, and adjust future scoring and recommendation logic based on received feedback.

8. A non-transitory computer-readable medium having stored thereon computer executable instructions which, when executed by a processor, cause the processor to perform the steps of:
(a) receiving user-defined relative weights for a plurality of travel preferences;
(b) normalizing the user-defined weights into a preference vector;
(c) scoring candidate travel options using the preference vector to generate a ranked set of itinerary elements;
(d) providing a real-time, natural-language explanation for each selected itinerary element that describes how the selection satisfies the user-defined preferences.
